(19) United States
(12) Patent Application Publication
(10) Pub. No.: US 2006/0050291 A1
(43) Pub. Date: Mar. 9, 2006

(54) Data management device, image output device, data management method and computer program product

(75) Inventors: Takeshi Morikawa, Takarazuka-shi (JP); Daisetsu Tohyama, Amagasaki-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 11/006,560

(22) Filed: Dec. 8, 2004

(30) Foreign Application Priority Data
Sep. 9, 2004 (JP) 2004-262280

(51) Int. Cl. G06F 3/12

(52) U.S. Cl. 358/1.13

(57) ABSTRACT

An image forming device includes a plurality of boxes, an active job database for storing job information about jobs, a job list generation portion for generating and displaying a job list screen for a user to select one of jobs, a relation box decision portion for deciding a box that is related to the job selected by the user, and a data list generation portion for performing the process of generating and displaying a data list screen that is a list of files stored in the decided box.

This application is based on Japanese Patent Application No. 2004-262280 filed on Sep. 9, 2004, the contents of which are hereby incorporated by reference.

### BACKGROUND OF THE INVENTION

1. Field of the Invention

The present invention relates to a method for handling data stored in a storage medium such as a hard disk. Particularly, the present invention relates to a method for handling image data that are used in an image output device such as multifunction devices.

2. Description of the Prior Art

Recently, an image forming device called a multifunction device or a multifunction peripheral (MFP) has been becoming widespread, which has functions of a copy machine, a scanner, a fax machine, a network printer and a document server. The function of the document server provides a storage area called a “personal box” or a “box” for each user in a storage medium such as a hard disk. Then, each user can store various data in his or her box. For example, the user can store image data of an image to be printed by the image forming device or image data of an image to be sent from the image forming device to another device.

Thanks to many functions of the image forming device and a large capacity of the hard disk, the boxes can store various data of large quantity. In addition, various types of jobs can be performed. Associated with this, manufacturers of image forming devices are required by users to improve usability of boxes and jobs. Therefore, several methods are proposed as described in the following documents.

Japanese unexamined patent publication No. 2002-323962 describes a method in which a user selects one of two box dialogs; one box dialog includes a list of box information about a plurality of boxes of a printer, and the other box dialog includes a list of box information about a box that was used as a destination for putting in a print job. Then, the user designates a box to be a destination for putting in a print job on a displayed box dialog.

Japanese unexamined patent publication No. 2003-110783 describes a method in which a file is displayed that can be deleted in a box when remaining storage capacity of the hard disk becomes small.

Japanese unexamined patent publication No. 2002-361970 describes a method in which one box is shared by many people, and when a user ID code is entered, image data having a connection with the user corresponding to the user ID code is searched in the box so that a name of the image data is displayed.

Japanese unexamined patent publication No. 2001-61035 describes a method in which a digital copy machine is connected with an electronic filing device for managing document data via a network. When a document is registered in the electronic filing device or a document is delivered from the electronic filing device, the digital copy machine displays a list of information of a document storage place such as a folder so that the user designates the document storage place such as a folder.

Japanese unexamined patent publication No. 2003-341157 describes a method in which when a predetermined type of error occurs during printing, a print job that generated the error is determined, and a logical link in which the error is associated with the print job is set in a memory of the printer. After that, the printer utilizes the logical link for searching the error that is associated with the print job by designating the print job, or for searching the print job that is associated with the error by designating the error.

However, according to the conventional method described above, usability for doing an operation about a job and an operation about a box consecutively is not always good for users. For example, it was easy to only delete a job that is registered in a queue, but it was troublesome to perform a subsequent operation for saving data of the job that is deleted. In this case, the user have to do the operation including (1) selecting a job to be deleted, (2) selecting a box for storing data of the job to be deleted and giving a storage command, (3) selecting the box again for opening the same, (4) confirming that the data is stored correctly and then closing the box, and (5) selecting the job to be deleted and giving a erase command.

In addition, when binding another job to the job registered in the queue or retrying the job that could not be completed normally, it was inconvenient to search data of the other job or data of the job that could not be completed normally by the conventional method.

### SUMMARY OF THE INVENTION

An object of the present invention is to improve a usability concerning jobs and boxes compared to before.

A data management device according to the present invention is a data management device for managing data that are used for performing a predetermined process. The data management device includes a plurality of storage areas for storing the data, a job information storage portion for storing job information about jobs of the predetermined process, a job list display portion for performing a process for displaying a job list screen for a user to select one of the jobs in accordance with the job information, a related storage area decision portion for deciding the storage area that is related to the job selected by the user, and a display portion for performing a process for displaying a data list screen that is a list of the data stored in the decided storage area.

The data management device can be applied to an image output device such as an MFP. In this case, the storage area stores output data as the data for outputting an image.

In the present invention, “binding another job to the job stored in the job information storage portion” means to combine these jobs into one group so that the process can be executed as one job.

According to the present invention, the user can see a list of data in a storage area that is related to the job only by designating the job. Thus, the user is not required to do an operation for searching the data like the conventional method when he or she wants to do a certain process on the data related to the job. Namely, usability can be improved.

According to another aspect of the present invention, when execution of a job is stopped but data of the job should be reserved, a user can readily select a storage area as a storage destination and check whether or not the data are stored correctly by an easier operation than the conventional method. According to another aspect of the present invention, it is easy to bind a job in an execution queue to another job related to the job. According to another aspect of the present invention, it is easy operation to retry a failed job or make an executed job be executed again.

### BRIEF DESCRIPTION OF THE DRAWINGS

FIG. 1 shows an example of an overall structure of a file sharing system.

FIGS. 2(a) and 2(b) show examples of a visual appearance and a hardware structure of an image forming device according to the present invention.

FIG. 3 shows an example of boxes and others provided in a hard disk.

FIG. 4 shows an example of a structure of a file.

FIG. 5 shows an example of a user information database.

FIG. 6 shows an example of a job history database.

FIG. 7 shows an example of a functional structure of the image forming device.

FIG. 8 shows an example of an active job database.

FIG. 9 is a flowchart explaining an example of a flow of a general process by the image forming device.

FIG. 10 shows an example of an initial menu screen.

FIG. 11 is a flowchart explaining an example of a flow of a process for designating a box or the like.

FIG. 12 shows an example of a user selection screen.

FIG. 13 shows an example of a password entry screen.

FIG. 14 shows an example of a file name entry screen.

FIG. 15 shows an example of a user selection screen.

FIG. 16 shows an example of a password entry screen.

FIG. 17 shows an example of a file name entry screen.

FIGS. 18 and 19 are flowcharts explaining an example of a flow of a job operation process.

FIG. 20 shows an example of an active job operation screen.

FIG. 21 shows an example of a file operation screen.

FIG. 22 is a flowchart explaining an example of a flow of a job history process.

FIG. 23 shows an example of a job history screen.

FIG. 24 shows an example of a file operation screen.

FIG. 25 shows an example of a file operation screen.

FIG. 26 shows an example of a job selection screen.

### DESCRIPTION OF THE PREFERRED EMBODIMENTS

Hereinafter, the present invention will be explained more in detail with reference to embodiments and drawings.

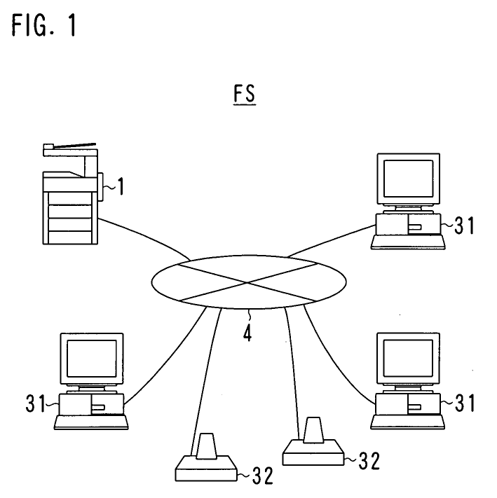

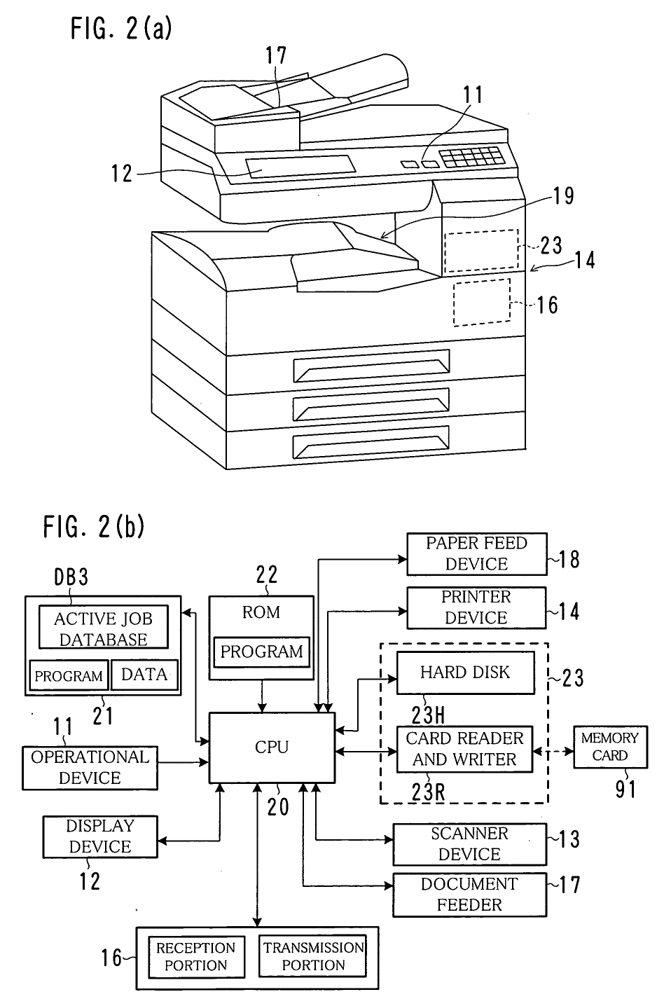

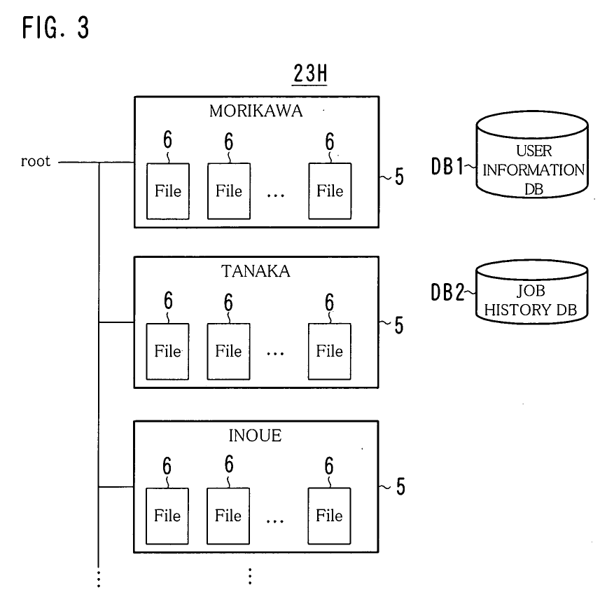

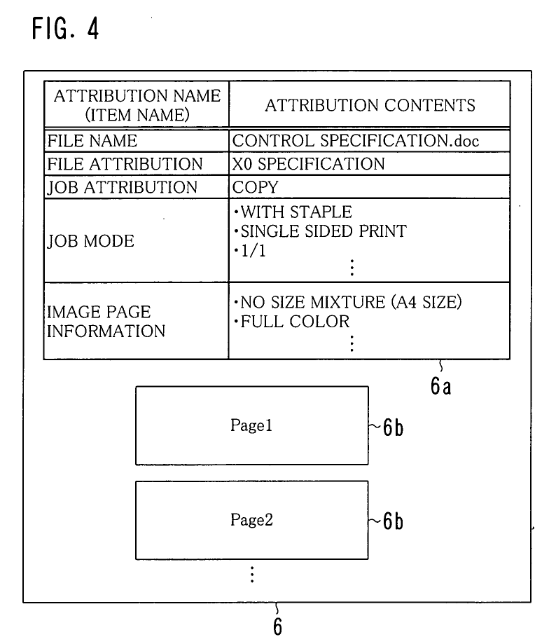

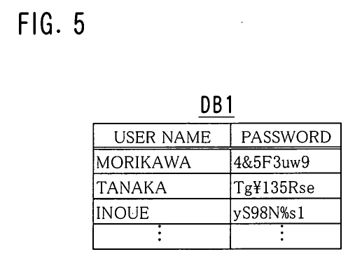

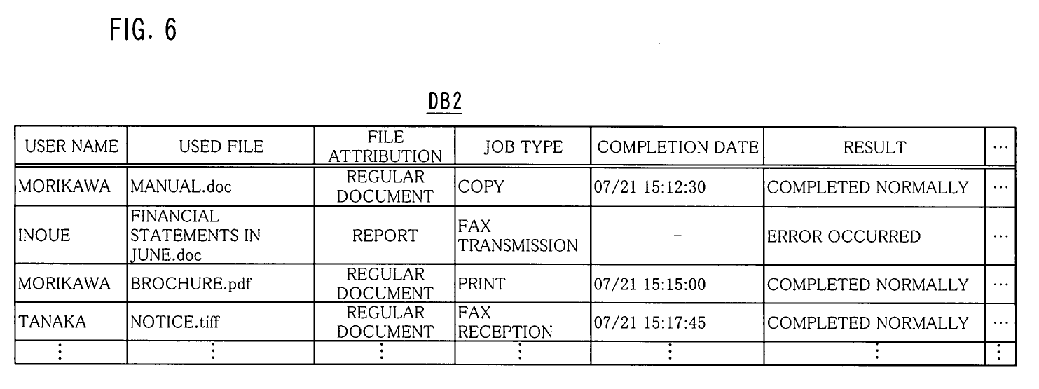

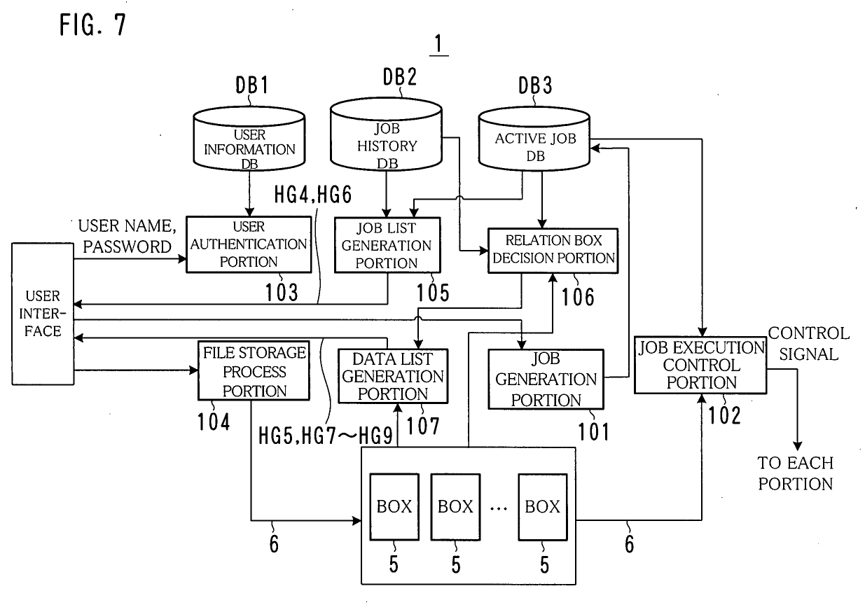

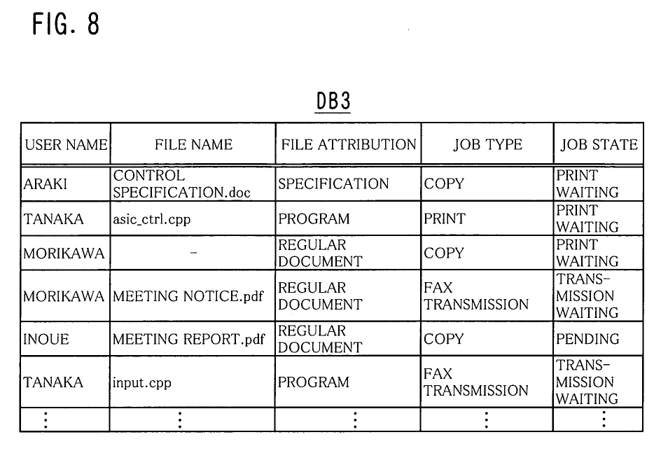

FIG. 1 shows an example of an overall structure of a file sharing system FS, FIGS. 2(a) and 2(b) show examples of a visual appearance and a hardware structure of an image forming device 1 according to the present invention, FIG. 3 shows an example of boxes 5 and others provided in a hard disk 23H, FIG. 4 shows an example of a structure of a file 6, FIG. 5 shows an example of a user information database DB1, FIG. 6 shows an example of a job history database DB2, FIG. 7 shows an example of a functional structure of the image forming device 1, and FIG. 8 shows an example of an active job database DB3.

As shown in FIG. 1, the file sharing system FS includes the image forming device 1 according to the present invention, one or more personal computers 31, one or more fax terminals 32 and a communication line 4. Each of the image forming device 1 and the personal computers 31 is given a computer name as ID information such as “PC001”, “PC002”, . . . for identifying each of them. Instead of the computer name, an IP address may be used as the ID information. Each of the fax terminals 32 is given a telephone number for a so-called fixed telephone or an IP telephone.

The image forming device 1, the personal computers 31 and the fax terminals 32 can be connected to one another via the communication line 4. As the communication line 4, a LAN, the Internet, a private line or a public telephone line is used. As a communication protocol or a communication standard, TCP/IP (Transmission Control Protocol/Internet Protocol), FTP (File Transfer Protocol), POP3 (Post Office Protocol version 3), SMTP (Simple Mail Transfer Protocol), IPP (Internet Printing Protocol), IEEE802.3 that is a standard for a wired LAN, IEEE802.11 that is a standard for a wireless LAN, or G3 (Group 3) or G4 (Group 4) standard for fax machines is used.

According to this file sharing system FS, users can share data stored in the hard disk of the image forming device 1 with the image forming device 1 and the personal computer 31. Instead of the personal computer 31, a workstation, a PDA (Personal Digital Assistant), a cellular phone or the like can be used.

The image forming device 1 is a device having integrated functions of a copy machine, a network printer, a scanner, a fax machine and a document server. It may be called a multifunction device or an MFP (Multi Function Peripheral).

This image forming device 1 includes, as shown in FIG. 2(a) of a visual appearance and in FIG. 2(b) of a hardware structure, an operational device 11, a display device 12, a scanner device 13, a printer device 14, a communication interface 16, a document feeder 17, a paper feed device 18, a tray 19, a CPU 20, a RAM 21, a ROM 22 and a data memory portion 23.

The operational device 11 includes a plurality of keys for entering numeric characters, other characters and symbols, a sensor for recognizing a pressed key and a transmission circuit for transmitting a signal indicating a recognized key to the CPU 20.

The display device 12 displays a screen for informing the user of a message or an instruction, a screen for the user to enter contents of setting and contents of a process and a screen for indicating an image generated in the image forming device 1 and a result of the process. In this embodiment, a touch panel is used as the display device 12. Therefore, the display device 12 has a function of detecting a position where the user touches by his or her finger on the touch panel and transmitting a signal indicating the detected result to the CPU 20.

In this way, the operational device 11 and the display device 12 play a roll of a user interface for the user to operate the image forming device 1 directly. Note that an application program and a driver for giving instructions to the image forming device 1 are installed in the personal computer 31. Therefore, the user can operate the image forming device 1 from a remote location by using the personal computer 31.

The scanner device 13 reads images including photographs, characters, pictures and charts in an original photoelectrically so as to generate digital image data (i.e., density data that indicate RGB or black density, here). The image data obtained as described above are used for the printer device 14 to print. Alternatively, the data are converted into a file of a format such as TIFF (Tagged Image File Format) or PDF (Portable Document Format) so as to be stored in the data memory portion 23 or transmitted to the personal computer 31. Alternatively, the data are converted into fax data to be transmitted to the fax terminal 32. The document feeder 17 is disposed at an upper portion of the main body of the image forming device 1 and is used for feeding one or more sheets of original to the scanner device 13 sequentially.

The printer device 14 prints an image that is read by the scanner device 13, an image of image data that are received from the personal computer 31 or an image of fax data that are received from the fax terminal 32 on a record sheet such as paper or film. The paper feed device 18 that is disposed at a lower portion of the main body of the image forming device 1 is used for feeding record sheets that are suitable for the image to be printed to the printer device 14. The record sheet on which the image is printed by the printer device 14, i.e., a printed matter is ejected to the tray 19.

The communication interface 16, which includes a transmission portion and a reception portion, is a device for exchanging data with the personal computer 31 and the fax terminal 32. As the communication interface 16, a NIC (Network Interface Card), a modem, a TA (Terminal Adapter) or the like is used.

The data memory portion 23 includes the hard disk 23H and a card reader and writer 23R. The card reader and writer 23R reads data from a memory card 91 such as a compact flash (registered trade mark) or smart media, or writes data into the memory card 91. The memory card 91 is used mainly for exchanging data with the personal computer 31 without using the communication line 4 or used for data backup.

The hard disk 23H includes personal boxes that are storage areas assigned to users for storing their data as the files 6 as shown in FIG. 3. The personal box corresponds to a “directory” or a “folder” in a personal computer or a workstation. Hereinafter, this personal box is referred to as a “box 5”. The box 5 has a box name for being distinguished from other boxes 5. In this embodiment, a user name of the user who is an owner of the box is used as the box name.

The user can store the file 6 in the box 5 by transferring the file 6 from the personal computer 31. Alternatively, the user can set a memory card 91 storing the file 6 to a slot of the card reader and writer 23R for copying the file so as to store the file 6 in the box 5. Furthermore, the user can store the file 6 in the box 5 in the following case, too.

For example, when the user makes an instruction to copy an original that is set to the document feeder 17, the image forming device 1 reads images from the original and converts the image data into the file 6, which is stored in the box 5 of the user. In addition, when the user makes an instruction to transmit image data of images of an original that is set to the document feeder 17 to the personal computer 31, image data of the read image are converted into the file 6 and stored in the box 5 of the user similarly. When an instruction to print a document is received from the personal computer 31 of the user (as network printing), the image forming device 1 stores the image data of the document received from the personal computer 31 as the file 6 in the box 5 of the user. If fax data are received from the fax terminal 32, the image forming device 1 stores the fax data as the file 6 in the box 5 of the user who is a receiver. If an instruction is made to transmit an image of an original that is set to the document feeder 17 to the fax terminal 32, image data of the read image are converted into the file 6, which is stored in the box 5 of the user.

The file 6 that is stored in the box 5 includes attribution information 6a and real image data 6b as shown in FIG. 4. The attribution information 6a indicates attribution of the file 6. The real image data 6b are data of contents (such as images, texts or charts) of pages that constitute the document of the file 6.

The “file name” of the attribution information 6a is ID information for distinguish the file 6 from other files 6 stored in the same box 5. Therefore, plural files 6 having the same file name cannot be saved in the same box 5 but can be saved in different boxes 5. A “file attribution” is information for classifying contents of the document of the file 6, and the user can decide the file attribution for his or her convenience.

A “job attribution” indicates what process the file 6 executes. Namely, a value of the job attribution is decided depending on what instruction the user makes and how the file 6 was stored in the box 5.

In the example shown in FIG. 4, the job attribution has a value of “copy”. This means that the file 6 is a file for copying an original and that the file 6 was generated by converting image data of an image read from the original into a file in accordance with the copy instruction made by the user and was stored in the box 5.

Other than that, the job attribution may have a value such as a “scan”, a “print”, a “fax transmission” or a “fax reception”. The value “scan” means that the file 6 is a file for transmitting an image of a scanned original to the personal computer 31 and that the file 6 was generated by converting image data of an image read from the original into a file in accordance with the scan instruction made by the user and was stored in the box 5. The value “print” means that the file 6 is a file for printing an image of a document prepared in the personal computer 31 and that the file 6 was obtained from the personal computer 31 in accordance with the print instruction made by the user and was stored in the box 5. The value “fax transmission” means that the file 6 is a file for transmitting an image of a scanned original to the fax terminal 32 and that the file 6 was generated by converting image data of an image read from the original in accordance with the fax transmission instruction made by the user into a file of a fax format and was stored in the box 5. The value “fax reception” means that the file 6 is a file for printing an image that was received from the fax terminal 32 and that the file 6 was generated by converting the fax data of the received image into a file and was stored in the box 5.

A “job mode” of the attribution information 6a indicates what condition is used for executing a process indicated in the “job attribution”. The example shown in FIG. 4 shows that the copy process should be performed by the condition including “with staple” for finishing the printed matter, “single sided print” for printing on a record sheet and “1/1” for a magnification. Other various conditions can be set as the “job mode”, which include color or monochrome print, a density, finishing with punched holes, the number of printed copies, and a destination of transmission.

The “image page information” of the attribution information 6a indicates attribution of the real image data 6b. For example, it indicates attribution about a print size and a print color of a page of the real image data 6b.

Note that the above-mentioned values are not set to the job attribution and the job mode in the file 6 that is simply received from the personal computer 31 or simply copied from the memory card 91.

Furthermore, the hard disk 23H stores a user information database DB1 and a job history database DB2.

The user information database DB1 includes information about users who use the image forming device 1 as shown in FIG. 5. The “user name” is ID information for identifying each user. This user name is used when a user logs in the image forming device 1. The “password” is information for user authentication when a user logs in.

The job history database DB2 includes information about processes (jobs) executed by the image forming device 1 and information about processes that the image forming device 1 could not complete (i.e., failed) as shown in FIG. 6. The “user name” shows the user name of the user who registered a job (i.e., who made an instruction to execute a process). However, it indicates a user name of the user who is a receiver in the case of the fax reception process. A “job type” indicates a type of the job that was executed or the job that was failed. A “used file” and a “file attribution” respectively indicate a file name and file attribution of the file 6 of the data that were used in the process. A “completion date” indicates a date and time when execution of the process is completed. A “result” indicates whether the execution of the process was completed normally or an error occurred.

With reference to FIG. 2 again, the ROM 22 stores a program and data for realizing basic functions of the image forming device 1 such as reading (scanning) of an image, copy of an original, transmission and reception of fax data, network printing and a document server (a box function). Other than that, the ROM 22 stores a program and data for realizing functions including a job generation portion 101, a job execution control portion 102, a user authentication portion 103, a file storage process portion 104, a job list generation portion 105, a relation box decision portion 106 and a data list generation portion 107 as shown in FIG. 7. A whole or a part of the program or the data may be installed in the data memory portion 23. In this case, the program or the data installed in the data memory portion 23 is loaded into the RAM 21 if necessary. Alternatively, a whole or a part of these functions may be realized by a processor (a circuit).

The RAM 21 temporarily stores data received from the personal computer 31 or the fax terminal 32, data for transmitting to the personal computer 31 or the fax terminal 32 and data that are generated by the scanner device 13. As the RAM 21, a nonvolatile RAM may be used.

In addition, the RAM 21 stores the active job database DB3. This active job database DB3 includes information about a process (a job) in an execution queue as shown in FIG. 8. Namely, the active job database DB3 is information showing the queue. As a rule, the jobs are executed in the order from the upper line to the lower line sequentially.

A “user name” shows a user name of a user who made the request for the job. A “job type” indicates a type of the job. A “job state” indicates a present state of the job. The “job state” of a job that can be executed promptly in the sequence stores a value of “ . . . waiting”. The “job state” of a job that is pending for execution stores a value of “pending”. In this case, when it comes this job's turn, it is skipped until the pending state is cancelled.

The CPU 20 executes a program that is stored in the ROM 22 or a program that is loaded into the RAM 21 so as to control the entire of the image forming device 1.

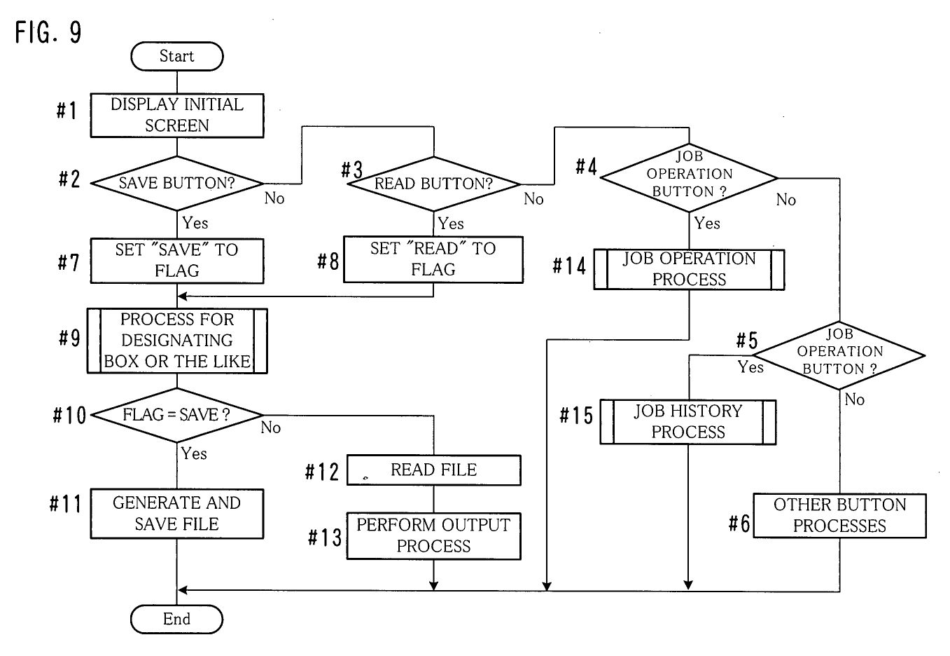

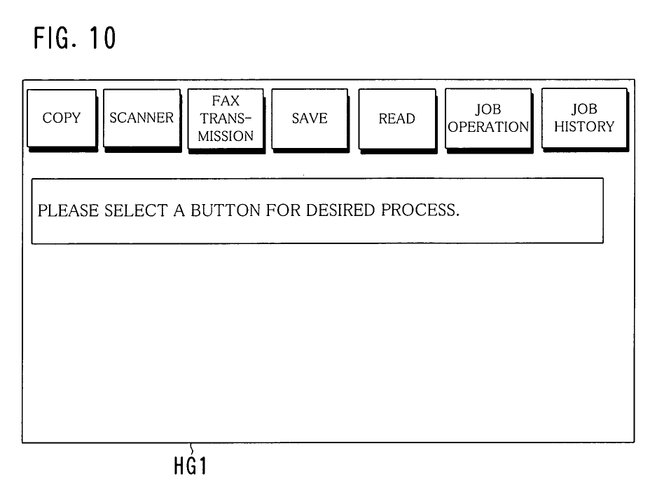

FIG. 9 is a flowchart explaining an example of a flow of a general process by the image forming device 1, and FIG. 10 shows an example of an initial menu screen HG1.

Next, functions and contents of processes of each portion of the image forming device 1 shown in FIG. 7 will be described. The job generation portion 101 performs a process for generating a file from image data obtained by the scan process of the scanner device 13, print data received from the personal computer 31 or fax data received from the fax terminal 32 so as to generate the file 6. The file storage process portion 104 performs a process for storing the generated file 6 in a predetermined box 5.

The job execution control portion 102 performs control of each portion of the image forming device 1 so that the job is executed in accordance with a queue of the active job database DB3 shown in FIG. 8. The user authentication portion 103 performs the user authentication of a user who is making the image forming device 1 perform the predetermined process. The job list generation portion 105 and the data list generation portion 107 generate a list of predetermined jobs and a list of predetermined files 6, respectively. The relation box decision portion 106 decides a box 5 that is related to a job designated by the user.

The functions and the contents of the processes of the job generation portion 101 and the data list generation portion 107 will be described more in detail with reference to a flowchart shown in FIG. 9. Note that a program for realizing a process of each flowchart is stored in the ROM 22 or the hard disk 23H, and the CPU 20 controls each portion of the image forming device 1 in accordance with the program so that each operation in the flowchart is executed.

The display device 12 of the image forming device 1 displays the initial menu screen HG1 as shown in FIG. 10 when no one operates the image forming device 1 directly (#1 in FIG. 9). A user who will make the image forming device 1 perform the process presses and selects a button corresponding to the desired process in the initial menu screen HG1.

If a “copy” button, a “scanner” button or a “fax transmission” button is selected (No in all of #2-#5), a screen for designating a condition of a process corresponding to the button (hereinafter referred to as a “process condition designation screen”) is displayed, and the user is requested to enter a condition. When a condition is entered, the job generation portion 101 generates a job for performing the process selected in the initial menu screen HG1 in accordance with the condition, and this job is registered in the active job database DB3 (see FIG. 8). The job execution control portion 102 controls each portion so that the job is executed in turn (#6).

For example, when the “copy” button is selected, the display device 12 is controlled to display the process condition designation screen for the designation of conditions including the number of copies, a magnification or reduction ratio, a density, color print or not, double sided print or not and finishing (with or without stapes and punched holes). The job generation portion 101 generates a job for copying under the designated condition and registers the job in the active job database DB3. Then, the job execution control portion 102 controls the scanner device 13 or others so as to read an image of an original that is set to the document feeder 17 in accordance with the condition designated by the user when it comes the job's turn, and it controls the printer device 14 to print the image on the record sheet.

When the “scanner” button is selected, the process condition designation screen is displayed for designation of conditions including image quality of read image, a density, a double sided original or not, a format of converting data of the read image into a file (TIFF, PDF or the like) and destination of transmission of the converted file. Then, similarly to the case of copy described above, the job is registered in the active job database DB3. When it comes the turn, the scanner device 13 and others are controlled so that an image of an original that is set to the document feeder 17 is read so that a file of the image is generated in accordance with the condition designated by the user, and the communication interface 16 is controlled to transmit the file to the designated destination.

When the “fax transmission” button is selected, the process condition designation screen is displayed for designation of conditions including a telephone number of a destination of transmission, image quality of a read image, a density and a double sided original or not. Then, similarly to the case of copy as described above, the scanner device 13 and others are controlled so that an image of an original that is set to the document feeder 17 is read so that fax data is generated in accordance with the condition designated by the user when it comes the turn, and the communication interface 16 is controlled to transmit the fax data.

When the “job history” button is selected, a list of jobs that were executed and jobs that were failed is displayed on the display device 12 in accordance with information stored in the job history database DB2 shown in FIG. 6.

Note that the user can make the image forming device 1 execute the print process from a remote location by using the personal computer 31. For example, the user opens a file of an image to be printed and enters a predetermined command after designating a print condition. Then, data for printing the image are sent from the personal computer 31 to the image forming device 1 together with information that indicates the print condition. When the image forming device 1 receives the data, a job of the print process is registered in the active job database DB3 similarly to the case of copy described above, and the print process is executed by the printer device 14 or the like when its turn comes.

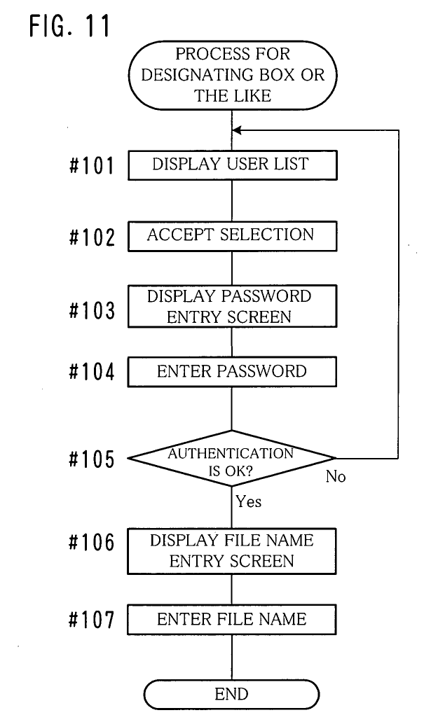

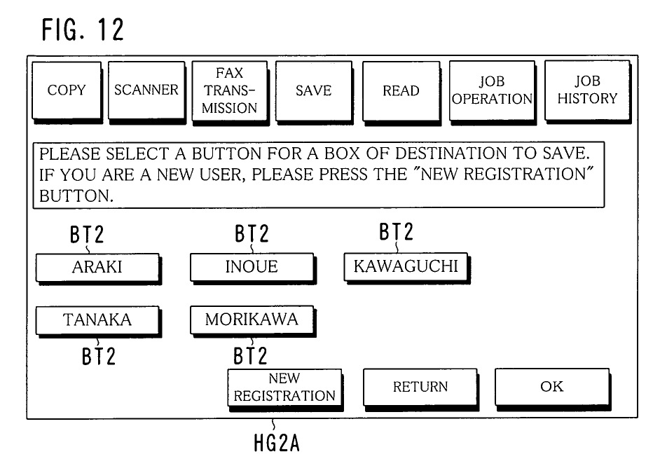

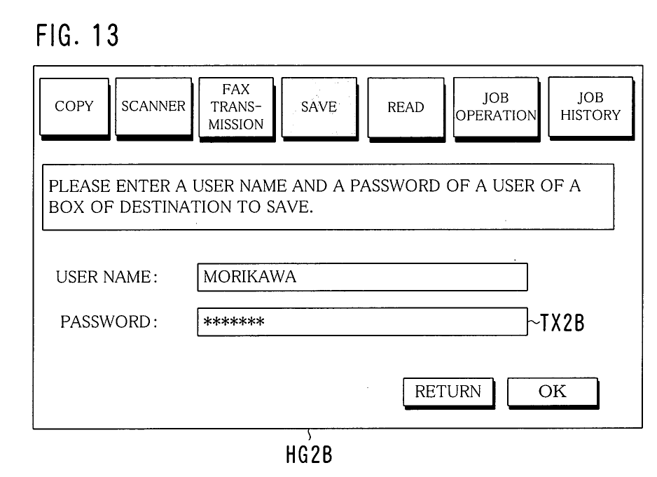

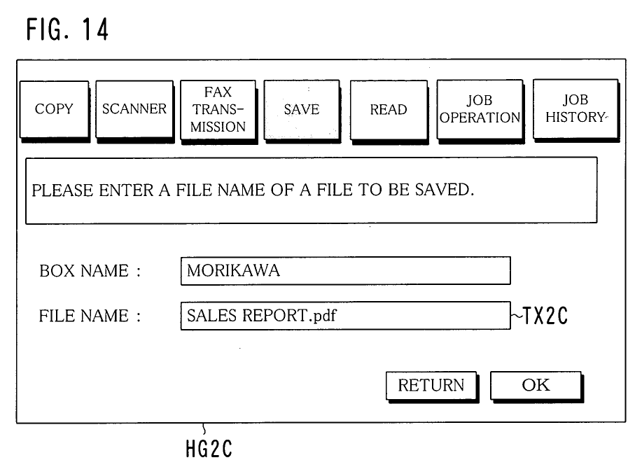

FIG. 11 is a flowchart explaining an example of a flow of a process for designating a box or the like, FIG. 12 shows an example of a user selection screen HG2A, FIG. 13 shows an example of a password entry screen HG2B, and FIG. 14 shows an example of a file name entry screen HG2C.

With reference to FIG. 9 again, the user selects one of the “copy” button, the “scanner” button and the “fax transmission” button in the initial menu screen HG1. When a “save” button is also pressed (Yes in #2), the file storage process portion 104 shown in FIG. 7 generates the file 6 for executing a process corresponding to the selected button and stores the file in the box 5. The generation and save of the file 6 are performed as follows.

A value of “save” is set to a process flag for indicating a state (a type) of a process to be performed (#7). A process for designating a file name of the file 6 to be saved and a box 5 as a saving destination is performed in the procedure as shown in FIG. 11 (#9).

Namely, a user selection screen HG2A shown in FIG. 12 is displayed on the display device 12 (#101). Here, the user finds a user select button BT2 on which his or her user name is written so as to press and select the button. When the selected user select button BT2 is accepted (#102), the password entry screen HG2B shown in FIG. 13 is displayed (#103). Here, the user enters his or her password in the text box TX2B by using a key of the operational device 11 and presses the “OK” button. Note that FIG. 13 shows an example of the password entry screen HG2B where “MORIKAWA” button is pressed in the user selection screen HG2A shown in FIG. 12.

When the entered password is accepted (#104), the user authentication portion 103 is requested to execute a user authentication process. The user authentication portion 103 retrieves the password of the user selected in the user selection screen HG2A from the user information database DB1 (see FIG. 5) and compares the password with the accepted password so as to decide whether or not the user who are using the image forming device 1 is a correct user (#105).

Then, it is decided that the user is a correct user (Yes in #105), the user's log in to the image forming device 1 is completed, and a file name entry screen HG2C shown in FIG. 14 is displayed (#106). Here, the user decides a file name of a file to be saved, enters the file name in the text box TX2C, and presses “OK” button. Thus, the entered file name is accepted (#107). If the passwords are not identical, and it couldn't decide that the user is a correct user (No in #105), an error message is displayed for requesting the user to select the user name and enter the password again.

Thus, the location for saving the file 6 to be saved and the file name are designated. Namely, the box 5 corresponding to the user name accepted in the step #102 becomes the location for saving the file 6, while the file name that is accepted in the step #107 becomes the file name of the file 6.

Note that when a “return” button in each screen shown in FIG. 12, 13 or 14 referred above and in each screen that will be described later is pressed, the initial menu screen HG1 is displayed again. Then, the user can perform the selection about each item and other operation again from the beginning.

With reference to FIG. 9 again, the file storage process portion 104 generates the file 6 for executing the process selected in the initial menu screen HG1 and saves this file with a file name designated in the step #9 in the box 5 designated in the step #9 (Yes in #10, #11). The procedure for generating the file 6 is substantially the same as a part of the procedure described in the step #6.

For example, if the “copy” button is selected, a screen for designating a condition such as the number of copies and file attribution is displayed. An original image is read in accordance with contents designated by the user. The image data of the read original are converted into a predetermined format of real image data 6b (see FIG. 4), and the attribution information 6a is generated in accordance with the designated contents. Then, the file 6 is generated by grouping the attribution information 6a and the real image data 6b. When the “scanner” button is selected, a screen for designating a condition such as image quality of a read image and file attribution is displayed. An original image is read in accordance with the designated contents. Then, similarly to the case where the “copy” button is selected, the attribution information 6a and real image data 6b of the read original image are generated, and the file 6 is generated by grouping them. If the “fax transmission” button is selected, a screen for designating a condition such as a telephone number of a transmission destination and file attribution is displayed. The original image is read in accordance with the designated contents, and the real image data 6b for fax transmission is generated. Then, the attribution information 6a and the real image data 6b are generated, and the file 6 is generated.

Note that not only generating the file 6 for executing the process corresponding to the button selected in the initial menu screen HG1 and saving the file in the box 5, but also it is possible to execute the process promptly. Alternatively, without executing the process at that time, it is possible to execute the process later when the user makes the instruction. It is preferable that the user can select whether or not the process is executed promptly.

In addition, the user can save the file 6 for printing the image made by the personal computer 31 by the image forming device 1 in his or her own box 5. In this case, the user selects an option that corresponds to the “save” button in the initial menu screen HG1 when entering a command of the print process. Then, the file storage process portion 104 generates the file 6 by converting the print data received from the personal computer 31 into a file and saves the file in the box 5 of the user.

The user logs out of the image forming device 1 after a predetermined operation when finishing the use of the image forming device 1. In addition, it is possible to force the logout if a state without any operation continues for a predetermined time.

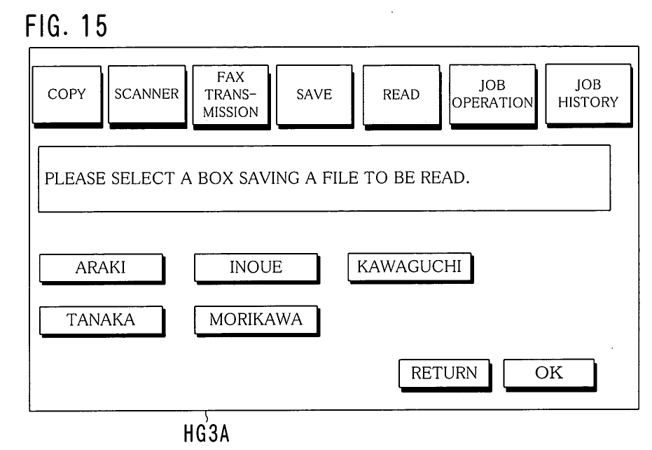

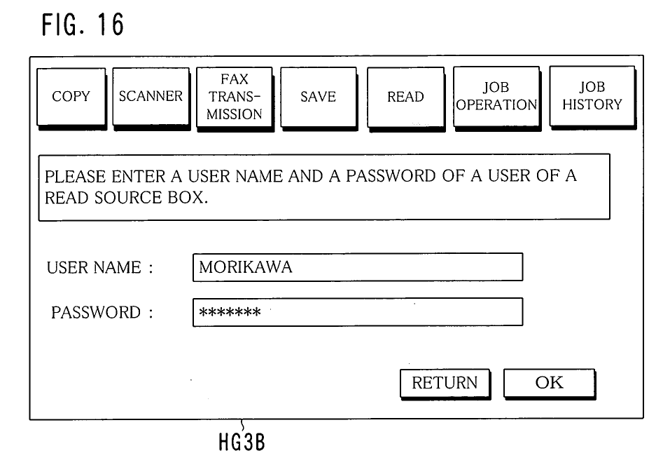

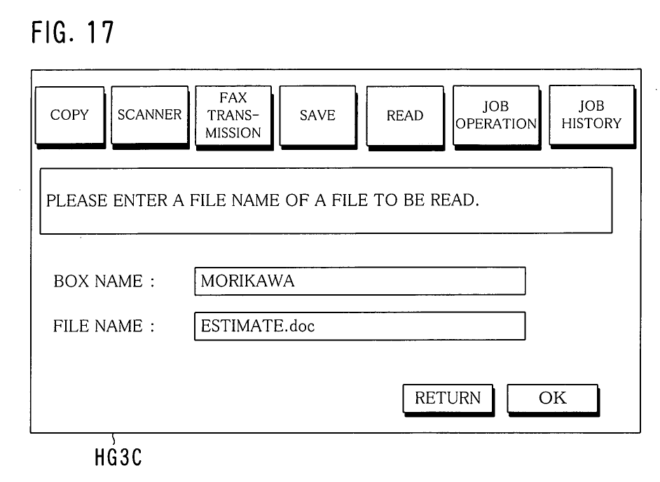

FIG. 15 shows an example of a user selection screen HG3A, FIG. 16 shows an example of a password entry screen HG3B, and FIG. 17 shows an example of a file name entry screen HG3C.

The user can read the file 6 that was stored in the box 5 by the process of the step #7, #9, #10 or #11 in FIG. 9 and make the image forming device 1 perform a desired process. In this case, the image forming device 1 performs the process in the following procedure.

When the user selects a “read” button in the initial menu screen HG1 shown in FIG. 10 (No in #2 and Yes in #3), a value of “read” is set to the process flag (#8) and user's designation of the file 6 to be read is accepted (#9). This procedure is basically the same as the case of designating a place of save and a file name in the storage process of the file 6 as described before, and it is as shown in FIG. 11. However, in the steps #101, #103 and #106 in FIG. 11, the user selection screen HG3A shown in FIG. 15, the password entry screen HG3B shown in FIG. 16 and the file name entry screen HG3C shown in FIG. 17 are displayed respectively instead of the user selection screen HG2A shown in FIG. 12, the password entry screen HG2B shown in FIG. 13 and the file name entry screen HG2C shown in FIG. 14, respectively.

The job generation portion 101 generates a job for producing an image of the file 6 that is saved in the box 5 that is designated in the step #9 and has the file name designated in the step #9 and registers it in the active job database DB3 shown in FIG. 8 (No in #10, #12). When it comes the turn to execute the job, the job execution control portion 102 controls the printer device 14, the communication interface 16 and others so as to perform a process for reading the file 6 designated in the step #9 and producing the real image data 6b by the contents of the condition indicated in the attribution information 6a (copy, print, file transfer, fax transmission or the like) (#13).

For example, if a job type of the job is “copy” or “print” and the attribution information 6a indicates a job mode (a process condition) of “with staples and double sided”, the printer device 14 is controlled so that a document of each real image data 6b of the file 6 is printed in a double sided manner and the printed matter is stapled. Furthermore, if the job type is “scan” and the attribution information 6a indicates a job mode of “transmission destination=MORIKAWA@˜.com”, the communication interface 16 is controlled so that the file 6 is attached to an electronic mail and the electronic mail is sent to the address.

Note that a program for sending screen data of a screen that is the same as each screen that is displayed on the display device 12 to the personal computer 31 and a program for receiving information entered in the screen from the personal computer 31 are installed in the image forming device 1. Thus, the user can read the file 6 saved in the box 5 so as to make the image forming device 1 execute the desired process by using his or her personal computer 31 from a remote location. In addition, the operation for the job operation process that will be described below can be performed by the personal computer 31.

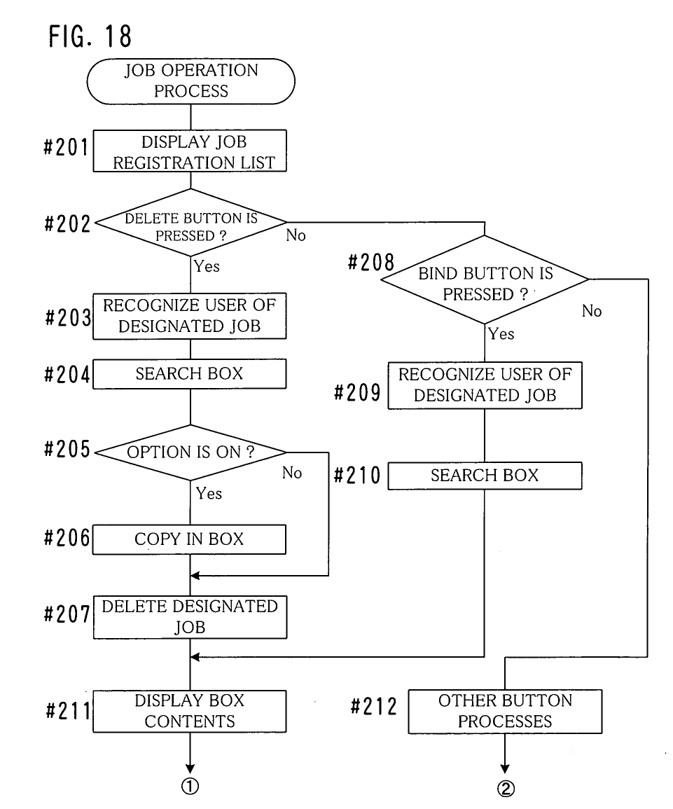

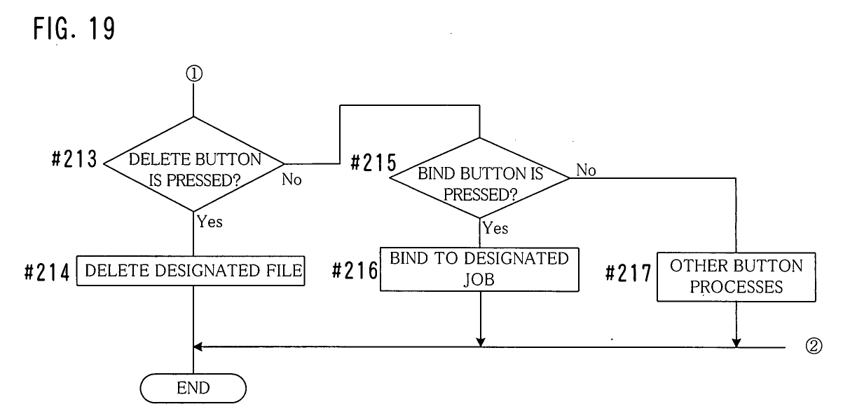

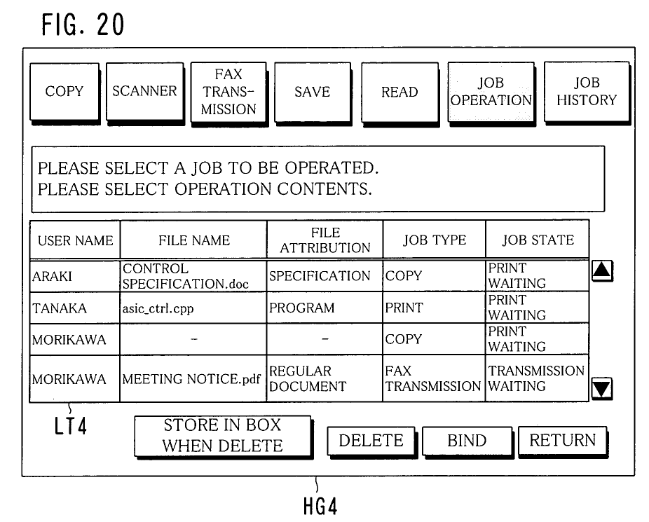

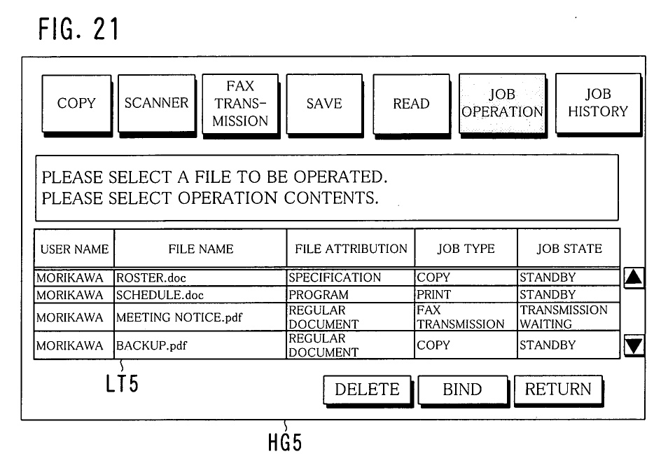

FIGS. 18 and 19 are flowcharts explaining an example of a flow of a job operation process, FIG. 20 shows an example of an active job operation screen HG4, and FIG. 21 shows an example of a file operation screen HG5.

The user can see a list of the file 6 that is saved in the box 5 that is related to a job by designating the job that is registered in the image forming device 1 and is not processed. On this occasion, the user can stop the execution of the designated job or add a new job.

In order to use these functions, the user presses a “job operation” button in the initial menu screen HG1 (see FIG. 10) (No in #2, No in #3 and Yes in #4 in FIG. 9). Then, the image forming device 1 executes a process for realizing these functions in the procedure as shown in FIGS. 18 and 19 (#14).

When the “job operation “button is pressed, the job list generation portion 105 shown in FIG. 7 refers to the active job database DB3 shown in FIG. 8 so as to generate an active job list LT4 that is a list of jobs of uncompleted processes and then displays the active job operation screen HG4 shown in FIG. 20 on the display device 12 (#201 in FIG. 18). Note that all the jobs may not be displayed on the screen depending on a screen size. In this case, the user can press a scroll button disposed at the right side of the active job list LT4 for scrolling the active job list LT4, so as to confirm all the jobs. This is the same in other lists such as a file list LT5 (see FIG. 21) that will be described later.

Here, if there is a job to be stopped, the user presses and selects a line including the job in the active job list LT4 and presses a “delete” button. Then (Yes in #202), the active job database DB3 deletes the data of the designated job (#207). Thus, the execution of the job is stopped.

Sequentially or in parallel with the process for stopping execution of the job, the relation box decision portion 106 recognizes a user who is related to the job (#203) and searches the box 5 of the user (#204). The data list generation portion 107 generates the file list LT5 that is a list of the file 6 saved in the box 5 and displays a file operation screen HG5 as shown in FIG. 21 on the display device 12 (#211). In this embodiment, as the user related to the job, a user who registered the job in the active job database DB3 (namely, a user who made the instruction for executing the job) is searched.

In addition, the user can save the data of the job as the file 6 in the box 5 when stopping execution of the job. In this case, the user presses and selects a “store in BOX when delete” button in advance before pressing the “delete” button in the active job operation screen HG4 shown in FIG. 20. Then (Yes in #205), the file storage process portion 104 converts the data for executing the job into a file so as to generate the file 6 before deleting the job designated in the active job list LT4, which is saved in the box 5 of the user in which the job was registered (#206). Namely, a process for copying the data for executing the job in the box 5 is performed.

In the file operation screen HG5, the user can delete the file 6 saved in the box 5 all together. The user presses and selects a line including the file 6 to be deleted in the file list LT5. If a plurality of files 6 should be deleted, plural lines of the files 6 are selected one by one using the scroll button disposed at the right side of the file list LT5 if necessary. Then, the “delete” button is pressed. Then (Yes in #213 in FIG. 19), the selected files 6 are deleted from the box 5 (#214).

In addition, the user can bind a new job to the job selected from the active job list LT4 shown in FIG. 20. In this case, the user presses a “bind” button in the active job operation screen HG4. Then (No in #202, Yes in #208 in FIG. 18), the relation box decision portion 106 and the data list generation portion 107 perform the process similar to the case in the steps #203 and #204, so as to generate the file list LT5 of the file 6 that is saved in the box 5 of the user related to the selected job and display the file operation screen HG5 (#209, #210 and #211).

Here, the user decides the job of the process for producing the file 6 to be bound to the selected job and selects the line including the file 6 in the file list LT5. It is possible to select plural lines. Then, the “bind” button is pressed. Then (No in #213 and Yes in #215 in FIG. 19), the job generation portion 101 shown in FIG. 7 generates a job for producing the selected file 6, and this job is bound to the job selected in the active job list LT4, which is registered in the active job database DB3 shown in FIG. 8. For example, the generated job is registered just after the job selected in the active job list LT4, and these jobs are handled as one group for the binding. Alternatively, it is possible to generate the job selected in the active job list LT4 again so that the process for producing the selected file 6 can be performed all together.

Note that it is possible to display a screen for designating an output condition of the file 6 selected in the file list LT5 (“job mode” of the attribution information 6a shown in FIG. 4) before binding the jobs so that the user can redesignate the job mode if necessary. In this case, the job for producing each of the files 6 is executed in accordance with the redesignated job mode.

In addition, if the job type of the job selected in the active job list LT4 is different from the job attribution of the file 6 selected in the file list LT5, it is possible to bind so that the process indicated in the former is executed. For example, it is supposed that the job type of the job selected in the active job list LT4 is “copy” and the job attribution of the file 6 selected in the file list LT5 is “fax transmission”. Then, it is possible not to consider the job attribution but to generate a job for copying an image of the real image data 6b of the file 6 so as to bind them.

If a button except for the “delete” button and for the “bind” button is pressed in the active job operation screen HG4 (No in #202 and No in #208 in FIG. 18), a process corresponding to each button is executed (#212). Contents of the process are the same as described for the step #6 in FIG. 9. If a button except for the “delete” button and for the “bind” button is pressed in the file operation screen HG5 (No in #213 and No in #215 in FIG. 19), a process corresponding to each button is executed similarly (#217).

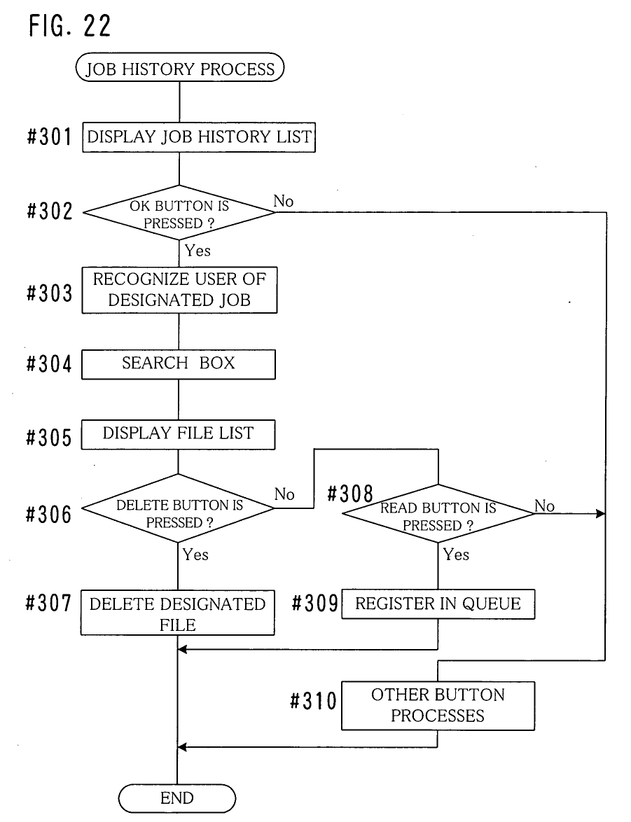

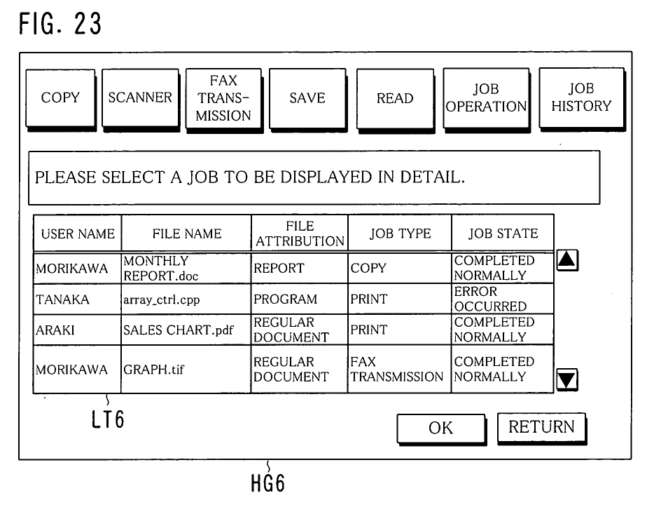

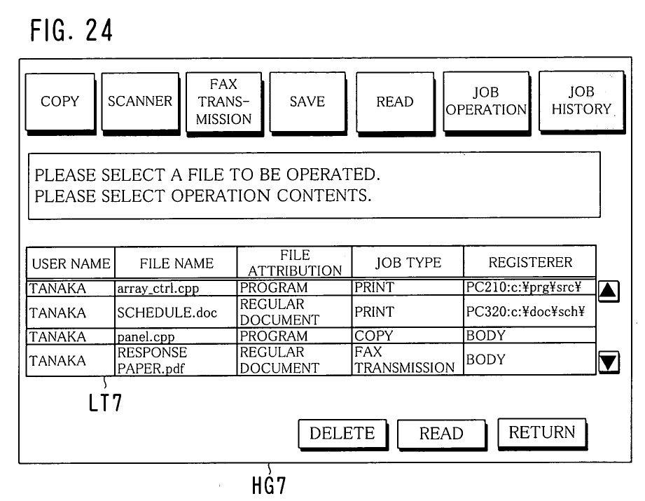

FIG. 22 is a flowchart explaining an example of a flow of a job history process, FIG. 23 shows an example of a job history screen HG6, and FIG. 24 shows an example of a file operation screen HG7.

The user can designate a job whose process is finished or a job whose process is failed in order to see a list of the file 6 that is stored in the box 5 related to the job. On this occasion, execution of the failed job can be retried, or unnecessary file 6 can be deleted.

If the user wants to use these functions, the user presses a “job history” button in the initial menu screen HG1 (see FIG. 10) (No in #2, No in #3, No in #4, Yes in #5 in FIG. 9). Then, the image forming device 1 executes a process for realizing these functions in the procedure shown in FIG. 22 (#15).

The job list generation portion 105 shown in FIG. 7 generates a job history list LT6 that is a list of jobs whose processes are completed and jobs whose processes are failed, and displays the job history screen HG6 as shown in FIG. 23 on the display device 12 (#301 in FIG. 22).

Here, if the user wants to retry the execution of a failed (i.e., abnormally finished) job, the user presses and selects a line corresponding to the job in the job history list LT6, and then presses the “OK” button. Then (Yes in #302), the relation box decision portion 106 recognizes the user related to the job (in this embodiment, a user who registered the job in the active job database DB3) (#303) and searches the box 5 of the user (#304). The data list generation portion 107 generates a file list LT7 that is a list of the file 6 that is stored in the box 5 and displays the file operation screen HG7 as shown in FIG. 24 on the display device 12 (#305).

Note that in the file list LT7, “registerer” indicates which device provided the file 6 and registered (stored) the same in the box 5. For example, “P0:C:\prg\src” means that the file 6 is copied (or moved) from the directory “\prg\src” in the drive C of the personal computer 31 having the computer name “PC210” to the box 5. Furthermore, “body” means that the file 6 was generated when the scanner device 13 of the image forming device 1 read an original image, or was copied from the memory card 91 that is set to the card reader and writer 23R. In addition, the line including the file 6 corresponding to the job selected in the job history list LT6 (namely, the file 6 necessary for executing the job) is in the selected state as default (for example, in a gray display).

If the user wants to retry the execution of the process for delivering the selected file 6, the user presses the “read” button. If there is another file 6 to be delivered together with the file 6, the user presses and selects the line including the corresponding file 6 and then presses the “read” button. Then (No in #306 and Yes in #308), the job generation portion 101 generates the job for delivering the image of the file 6 selected in the file list LT7 and registers it in the active job database DB3 shown in FIG. 8 (#309). After that, when the job's turn comes, execution of the job that was failed the last time is retried.

In addition, the user can select the job whose process is completed normally from the job history list LT6 and let the job be executed again. The procedure in this case is the same as the case of retrying the job whose process is failed, i.e., the case of FIG. 22.

In the file operation screen HG7, it is possible to delete the file 6 stored in the box 5. In this case, the user presses and selects the line including the file 6 to be deleted in the file list LT7 and presses the “delete” button (Yes in #306). Then, the selected file 6 is deleted from the box 5 (#307).

If a button except for the “OK” button is selected (No in #302) in the job history screen HG6, or a button except for the “delete” button and for the “read” button is selected in the file operation screen HG7 (No in #308), the process corresponding to the selected button is executed (#310). Contents of this process are the same as the contents described in the step #6 in FIG. 9.

According to this embodiment, usability concerning the job and the box can be improved more than before. For example, if the user wants to save data necessary for a job while deleting the job, the user only selects the job in the active job operation screen HG4 shown in FIG. 20 and presses a “save in the BOX when deleting” button and a “delete” button. Then, the data necessary to the job is saved in the box 5 of the user automatically, and the file operation screen HG5 shown in FIG. 21 is displayed for confirming whether or not it is saved normally.

In addition, when the user wants to bind another job to a job waiting execution, the user only selects the job waiting execution in the active job operation screen HG4 and presses the “bind” button so as to see the list screen (the file operation screen HG5) of the file 6 that is necessary for another job to be bound.

If the user wants to perform any process of a job that was not executed correctly, the user only selects the job from the job history screen HG6 shown in FIG. 23 and presses the “OK” button, so that the list screen including the file 6 of the job (the file operation screen HG7 in FIG. 24) can be seen. Then, in this list screen, it is decided easily what process is executed for the file 6 of the job.

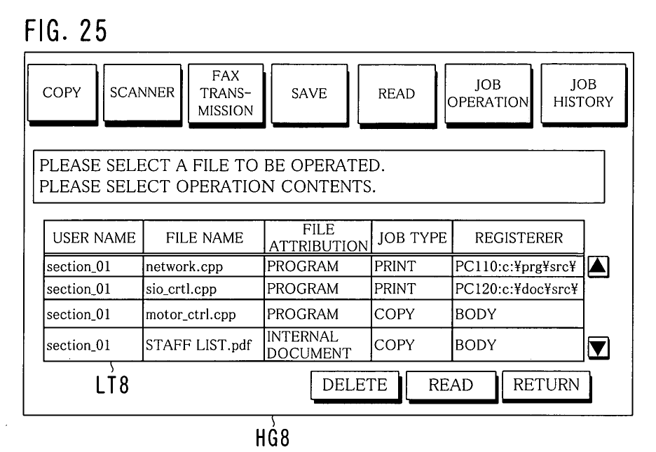

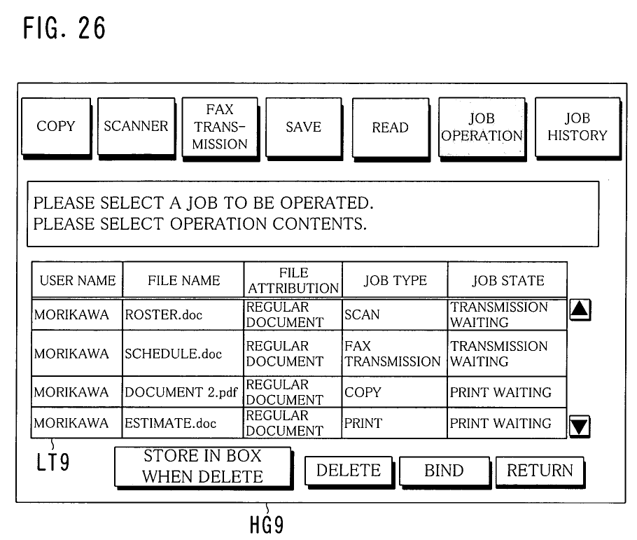

FIG. 25 shows an example of a file operation screen HG8, and FIG. 26 shows an example of a job selection screen HG9.

In this embodiment, when one of the jobs is selected in the active job operation screen HG4 shown in FIG. 20 or in the job history screen HG6 shown in FIG. 23, the relation box decision portion 106 shown in FIG. 7 decides that the box 5 of the user who registered the job in the active job database DB3 is the box 5 corresponding to the job (hereinafter referred to as a “corresponding box”). However, it is possible to decide that another box 5 is the corresponding box.

For example, if the file sharing system FS is placed in a company or in an office and the box 5 is assigned to each group (division), it is possible to decide that the box 5 of a group to which the user belongs is the corresponding box. In this case, the job list generation portion 105 generates the file list LT8 of the file 6 stored in the box 5 of the group to which the user belongs and displays the file operation screen HG8 as shown in FIG. 25 on the display device 12.

Alternatively, it is possible to decide that both the box 5 of a group to which the user belongs and the box 5 of the individual user are the corresponding box. In this case, it is possible to display the file list LT5 or LT7 of the individual box 5 (see FIGS. 21 and 24) and the file list LT8 of the boxes 5 of groups on one screen. If two of them cannot be displayed at one time due to a small size of the screen, a predetermined button may be pressed for switching the display of the list.

Alternatively, if the box 5 is provided for each of the types of the processes (job attribution) such as “print”, copy”, scan”, or “fax transmission” and the file 6 is stored in the box 5 corresponding to his or her own job attribution (see FIG. 4), it is possible to decide that the box 5 having the same job attribution as the job type of the job selected in the active job operation screen HG4 or the job history screen HG6 is the corresponding box.

In this embodiment, when one of the jobs is selected in the active job operation screen HG4 and a predetermined button is pressed, the file operation screen HG5 is displayed promptly. However, if many jobs are registered in the active job database DB3 (see FIG. 8), the user cannot find readily a job to be selected in the active job list LT4 of the active job operation screen HG4. Therefore, it is possible to display the file operation screen HG5 as follows.

A button that is used when the user gives instruction for narrowing down jobs to the image forming device 1 is provided to the active job operation screen HG4. If the user cannot find a job to be selected, the user selects another job that is registered by the user who registered the former job in the active job list LT4 and presses the button for narrowing down. Then, the job list generation portion 105 selects other jobs having the same relationship with the job (here, jobs registered by the same user) from the active job database DB3, generates the file list LT9 indicating the result, and displays the job selection screen HG9 as shown in FIG. 26 on the display device 12. Thus, the jobs related to the user can be found from many jobs. Here, when one of the jobs is selected and the “delete” button or the “bind” button is pressed, the file operation screen HG5 including the file list LT5 corresponding to the job is displayed in the same manner as the procedure described before in the steps #202-#211 in FIG. 18. Note that it is possible to display the file list LT5 and the file list LT7 in one screen.

Similarly in the job history screen HG6, the button for narrowing down may be provided. When one of the jobs is selected and the corresponding button is pressed, jobs having the same relationship with the job are selected from the job history database DB2 and are displayed in a screen similarly to FIG. 26. Then, if one of the jobs is selected from these jobs and a predetermined button is pressed, the file operation screen HG7 including the file list LT7 corresponding to the job is displayed in the same manner as the procedure described in the steps #302-#305 in FIG. 22.

The present invention can be applied to a fax terminal, a printer device or an image reading device other than the MFP. It can be also applied to a server that is connected to a fax modem, a printer device or an image reading device.

Other than that, a whole or a part of the structure of the file sharing system FS, the image forming device 1, the contents of processes, the order of the processes, the output conditions, the structure of the attribution information 6a and others can be modified if necessary in the scope of the present invention.

The present invention can be used suitably for improving usability of an image forming device such as an MFP.

While the presently preferred embodiments of the present invention have been shown and described, it will be understood that the present invention is not limited thereto, and that various changes and modifications may be made by those skilled in the art without departing from the scope of the invention as set forth in the appended claims.

What is claimed is:

1. A data management device for managing data that are used for performing a predetermined process, the device comprising:
a plurality of storage areas for storing the data;
a job information storage portion for storing job information about jobs of the predetermined process;
a job list display portion for performing a process for displaying a job list screen for a user to select one of the jobs in accordance with the job information;
a related storage area decision portion for deciding the storage area that is related to the job selected by the user; and
a display portion for performing a process for displaying a screen about the decided storage area.

2. The data management device according to claim 1, wherein the display portion displays a data list screen as the screen, the data list screen being a list of the data stored in the storage area that is decided by the related storage area decision portion.

3. An image output device comprising:
a plurality of storage areas for storing output data that are data for outputting an image;
a job information storage portion for storing job information about jobs of a process for outputting an image;
a job list display portion for performing a process for displaying a job list screen for a user to select one of the jobs in accordance with the job information;
a related storage area decision portion for deciding the storage area that is related to the job selected by the user on the job list screen in accordance with the job information of the job; and
a display portion for performing a process for displaying a screen about the decided storage area.

4. The image output device according to claim 3, wherein the display portion displays a data list screen as the screen, the data list screen being a list of the data stored in the storage area that is decided by the related storage area decision portion.

5. The image output device according to claim 3, wherein the job information of the job indicates a user who instructed execution of the job, and the related storage area decision portion decides that the storage area assigned to the user indicated in the job information of the job is the storage area that is related to the job.

6. The image output device according to claim 3, further comprising:
an output portion for outputting an image that includes at least one of a print portion for printing an image on a record sheet and a data transmission portion for transmitting data of an image to another device; and
a control portion for controlling the output portion so that the job is executed in accordance with the job information stored in the job information storage portion, wherein
the job information storage portion stores the job information of the job that is not executed yet, and
when an instruction to stop the execution of the job selected by the user on the job list screen is accepted,
the job information of the job is deleted from the job information storage portion, and
data that are used for executing the job are stored as the output data in the storage area decided by the related storage area decision portion.

7. The image output device according to claim 4, further comprising:
a job generation portion for generating a new job in accordance with an instruction from the user, wherein
the job information storage portion stores the job information of the job that is not executed yet, and
when an instruction to execute an output process of another image together with the job selected by the user on the job list screen is accepted,
the job generation portion generates the job about an image of the output data selected by the user on the data list screen, and
the job information storage portion stores the generated job being bound to the job selected by the user on the job list screen.

8. The image output device according to claim 3, further comprising:
a job generation portion for generating a new job in accordance with an instruction from the user, wherein
the job information storage portion stores the job information of the job that is completed normally or that is not completed normally, and
when an instruction to execute again the job selected by the user on the job list screen is accepted,
the job generation portion generates the job information of the job, and
the job information storage portion stores the generated job information.

9. The image output device according to claim 4, wherein when an instruction to delete data is accepted while the data list screen is displayed, the output data selected by the user on the data list screen is deleted from the storage area decided by the related storage area decision portion.

10. A data management method for managing data that are used for performing a predetermined process in a storage device having a plurality of storage areas, the method comprising:
a first step for storing job information about jobs of the predetermined process in a job information storage portion;
a second step for performing a process for displaying a job list screen for a user to select one of the jobs in accordance with the job information;
a third step for deciding the storage area that is related to the job selected by the user; and
a fourth step for performing a process for displaying a screen about the decided storage area.

11. The data management method according to claim 10, wherein the fourth step includes displaying a data list screen as the screen, the data list screen being a list of the data stored in the storage area decided in the third step.

12. The data management method according to claim 10, wherein the job information of the job indicates a user who made the instruction to execute the job, and the third step includes deciding that the storage area assigned to the user indicated in the job information of the job is the storage area that is related to the job.

13. The data management method according to claim 10, wherein
the predetermined process is a print process for printing an image on a record sheet by a print portion or a data transmission process for transmitting data of an image to a device other than the storage device by a data transmission portion,
the job information storage portion stores the job information of the job that is not executed yet,
the method further includes a fifth step for controlling the print portion or the data transmission portion so that the job is executed in accordance with the job information stored in the job information storage portion, and
when an instruction to stop the execution of the job is accepted before the process of the fifth step is performed in accordance with the job information of the job selected by the user on the job list screen in the second step,
a sixth step for deleting the job information of the job from the job information storage portion, and
a seventh step for storing data that are used for executing the job as the output data in the storage area decided by the related storage area decision portion are performed.

14. The data management method according to claim 10, wherein
the job information storage portion stores the job information of the job that is completed normally or that is not completed normally, and
when an instruction to execute again the job selected by the user on the job list screen is accepted, the job information of a newly generated job is stored in the job information storage portion in the first step.

15. A computer program product that is used in a computer for managing a storage device having a plurality of storage areas, the computer program product makes the computer execute processes including:
a storage process for storing job information about jobs of a predetermined process in a job information storage portion;
a first display process for displaying a job list screen for a user to select one of the jobs in accordance with the job information;
a decision process for deciding the storage area that is related to the job selected by the user; and
a second display process for displaying a screen about the decided storage area.

16. The computer program product according to claim 15, wherein the second display process is a process for displaying a data list screen as the screen, the data list screen being a list of the data stored in the storage area decided in the decision process.

17. The computer program product according to claim 15, wherein the job information of the job indicates a user who made the instruction to execute the job, and the decision process includes deciding that the storage area assigned to the user indicated in the job information of the job is the storage area that is related to the job.

18. The computer program product according to claim 15, wherein
the predetermined process is a print process for printing an image on a record sheet by a print portion or a data transmission process for transmitting data of an image to a device other than the storage device by a data transmission portion,
the job information storage portion stores the job information of the job that is not executed yet,
the processes further includes a control process for controlling the print portion or the data transmission portion so that the job is executed in accordance with the job information stored in the job information storage portion, and
when an instruction to stop the execution of the job is accepted before the control process is performed in accordance with the job information of the job selected by the user on the job list screen in the first display process,
a delete process for deleting the job information of the job from the job information storage portion, and
a storage process for storing data that are used for executing the job as the output data in the storage area decided by the related storage area decision portion are executed by the computer.

19. The computer program product according to claim 15, wherein
the job information storage portion stores the job information of the job that is completed normally or that is not completed normally, and
in the storage process, when an instruction to execute again the job selected by the user on the job list screen is accepted, the job information of a newly generated job is stored in the job information storage portion.
